(19) United States
(12) Patent Application Publication
(10) Pub. No.: US 2003/0172786 A1
(43) Pub. Date: Sep. 18, 2003

(54) Method and apparatus for removing waste from workpieces

(76) Inventor: XuDong Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/112,973

(22) Filed: Mar. 28, 2002

(30) Foreign Application Priority Data
Mar. 13, 2002 (TW) 91104671

(51) Int. Cl. B26D 3/00; B26D 5/08; B26F 1/14

(52) U.S. Cl. 83/39; 83/549; 83/691

(57) ABSTRACT

A method for removing waste from a die-cast metal workpiece includes: 1) removing run and overflow via a first cutting apparatus (10); and 2) removing burring via a second cutting apparatus (100). The first cutting apparatus includes a first upper die (12), a first lower die (40), and a plurality of pairs of aligned first punches (22). Each first punch includes a wedge-shaped first machining section (23). The second cutting apparatus includes a second upper die (102), a second lower die (140), and a plurality of second punches (122). Each second punch includes a stepped second machining section (123). The second machining section includes a plurality of progressively stepped machining portions (124). A topmost machining portion is the largest, and a bottommost machining portion is the smallest. Thus the second machining section can cut burring from the workpiece stepwisedly.

### BACKGROUND OF THE INVENTION

1. Field of the Invention

The present invention relates to methods and apparatuses for removing waste from workpieces, and particularly to methods and apparatuses for removing waste from workpieces that are produced by die-casting.

2. Description of Related Art

With rapid developments in notebook computer technology, the demand for products produced by die-casting is constantly increasing. Workpieces produced by die-casting often have three kinds of waste: run formed adjacent pouring ports of the workpieces, overflow formed adjacent vents of the workpieces, and burring formed on edges of the workpieces that are adjacent openings of the workpieces.

Conventional methods for removing run and overflow from a workpiece comprise manual means and mechanical means. In manual means, most of the waste is first removed by hand. The workpiece is then machined to remove residual waste. This procedure is time-consuming and laborious. In mechanical means, the workpiece is directly machined in a milling machine. Jigs are required to clamp the workpiece on the milling machine. There is a high risk of damage to the workpiece when the workpiece is made of brittle metal such as aluminum-alloy or magnesium-alloy.

A conventional method for removing burring from a workpiece involves manually using a file. This is time-consuming and laborious.

### SUMMARY OF THE INVENTION

Accordingly, an object of the present invention is to provide a method which can readily and efficiently remove waste from workpieces.

Another object of the present invention is to provide an apparatus which can readily remove waste from workpieces without damaging the workpieces.

In order to achieve the above-mentioned objects, a method for removing waste from a die-cast metal workpiece includes the following steps: 1) removing run and overflow via a first cutting apparatus; and 2) removing burring via a second cutting apparatus. The first cutting apparatus includes a first upper die and a first lower die. A plurality of pairs of aligned first punches is secured in the first upper die and first lower die respectively. Each first punch includes a wedge-shaped first machining section for cutting run and overflow from the workpiece, and a first locking section securing the first punch to the first upper die. The second cutting apparatus includes a second upper die and a second lower die. The second upper die includes a plurality of second punches. A profile of a cross section of each second punch corresponds to a profile of an opening of the workpiece at which the burring exists. The second punch includes a stepped second machining section for cutting burring from the workpiece, and a second locking section securing the second punch to the second upper die. The second machining section includes a plurality of progressively stepped machining portions. The machining portion nearest the second locking section is the largest, and the machining portion most distal from the second locking section is the smallest. Thus the second machining section can cut burring from the workpiece stepwisedly.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of a first cutting apparatus in accordance with the present invention;

FIG. 2 is an enlarged view of a first punch of the first cutting apparatus of FIG. 1;

FIG. 3 is a cross-sectional view of a second cutting apparatus in accordance with the present invention;

FIG. 4 is an enlarged view of a second punch of the second cutting apparatus of FIG. 3; and

FIG. 5 is an enlarged view of a circled portion V of FIG. 4.

### DETAILED DESCRIPTION OF THE PREFERRED EMBODIMENT

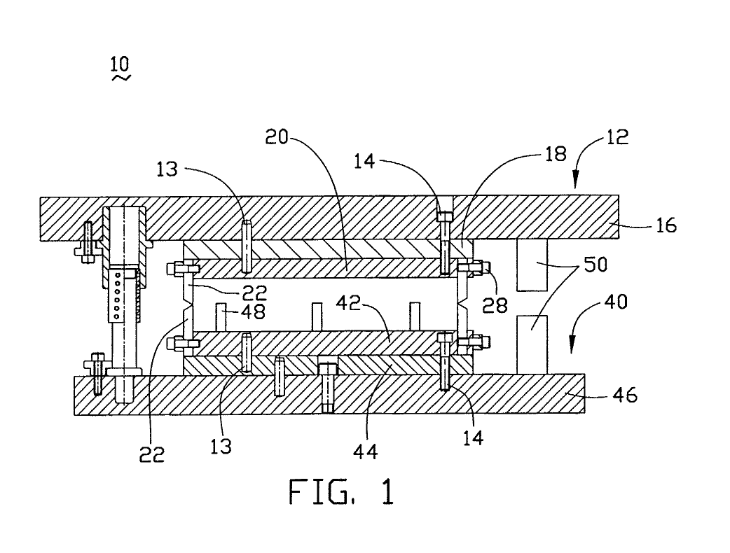

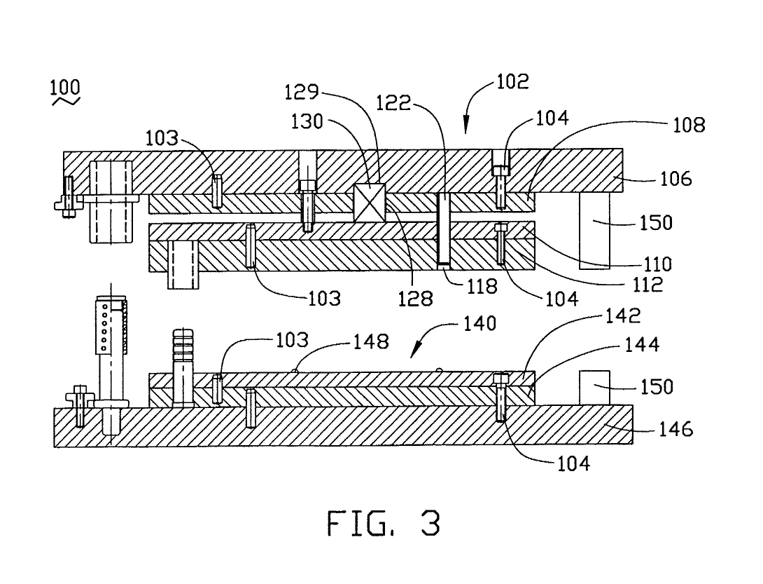

A metal workpiece produced by die-casting often has three kinds of waste: run formed adjacent pouring positions of the workpiece, overflow formed adjacent vents of the workpiece, and burring formed on edges of the workpiece that are adjacent openings defined in the workpiece. Referring to FIGS. 1 and 3, a method for removing waste from a die-cast workpiece in accordance with a preferred embodiment of the present invention comprises the following steps: 1) removing run and overflow from the workpiece in a first cutting apparatus 10; and 2) removing the burring from the workpiece in a second cutting apparatus 100.

Referring to FIG. 1, the first cutting apparatus 10 comprises a first upper die 12 and a first lower die 40. The first upper die 12 comprises a first punch set 16, a first punch pad 18 mounted to an underside of the first punch set 16, and a first punch holder 20 mounted to an underside of the first punch pad 18. The first punch set 16, first punch pad 18 and first punch holder 20 are fixed together by a plurality of first pins 13 and first bolts 14. The first lower die 40 comprises a first lower plate 42, a first lower pad 44, and a first die set 46. The first lower plate 42, first lower pad 44 and first die set 46 are fixed together by a plurality of more first pins 13 and first bolts 14. A pair of aligned first punches 22 is respectively secured to an end of the first punch holder 20 and to a corresponding end of the first lower plate 42 using a pair of screws 28. One of said first punches 22 protrudes below the first punch holder 20, and the other of said first punches 22 protrudes above the first lower plate 42. One of said screws 28 is horizontally extended through the corresponding first punch 22 to engage with the first punch holder 20. The other of said screws 28 is horizontally extended through the corresponding first punch 22 to engage with the first lower plate 42. Another pair of aligned first punches 22 is respectively secured to an opposite end of the first punch holder 20 and to a corresponding opposite end of the first lower plate 42 using another pair of screws 28. One of said first punches 22 protrudes below the first punch holder 20, and the other of said first punches 22 protrudes above the first lower plate 42. One of said screws 28 is horizontally extended through the corresponding first punch 22 to engage with the first punch holder 20. The other of said screws 28 is horizontally extended through the corresponding first punch 22 to engage with the first lower plate 42. A plurality of supporting blocks 48 is mounted on the first lower plate 42 within an area demarcated by the corresponding first punches 22, for supporting the workpiece thereon. Two pairs of aligned stopping blocks 50 (only one pair shown) are respectively mounted on the first punch set 16 and on the first die set 46, for limiting movement of the first upper die 12 relative to the first lower die 40.

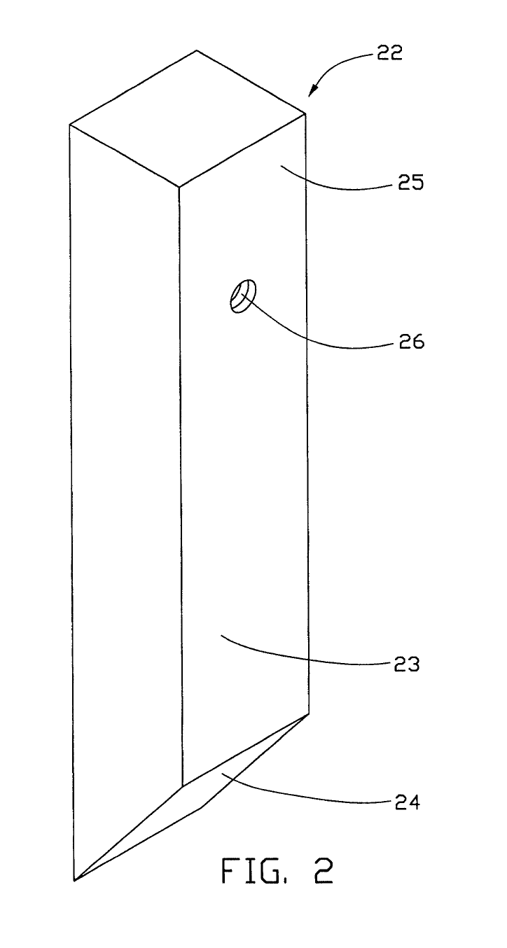

Referring to FIG. 2, each first punch 22 comprises a first machining section 23 and a first locking section 25 opposite to the first machining section 23. The first machining section 23 has a wedge-shaped first machining portion 24 formed on a distal end thereof. In the preferred embodiment, an angle formed by a distal end of the wedge-shaped first machining portion 24 is approximately 60 degrees. The locking section 25 defines a locking hole 26, for extension of the corresponding screw 28 therethrough (see FIG. 1).

Referring to FIG. 3, the second cutting apparatus 100 comprises a second upper die 102 and a second lower die 140. The second upper die 102 sequentially comprises from top to bottom: a second punch set 106, a second punch holder 108, a stripper pad 110, and an upper stripper 112. The second punch holder 108 is secured to an underside of the second punch set 106 by a plurality of second pins 103 and second bolts 104. The stripper pad 110 is secured on top of the upper stripper 112 by a plurality of more second pins 103 and second bolts 104. The stripper pad 110 is spaced a predetermined distance below the second punch holder 108. A plurality of sets of aligned through holes 118 (only one set shown) is defined in the second punch holder 108, the stripper pad 110 and the upper stripper 112 respectively. A plurality of second punches 122 is fixedly secured in the through holes 118 of the second punch holder 108 respectively. Each second punch 122 extends through the corresponding through hole 118 of the stripper pad 110 and into the corresponding through hole 118 of the upper stripper 112. When the second cutting apparatus 100 is in a non-operating state, a distal end of the second punch 122 is located entirely within the second through hole 118 of the upper stripper 112. When the second cutting apparatus 100 is in operation, the distal end of the second punch 122 can protrude beyond a bottom surface of the upper stripper 112. A through opening 128 is defined in the second punch holder 108. A recess 129 is defined in a bottom face of the second punch set 106, in communication with the through opening 128. A spring 130 is accommodated in the recess 129 and the through opening 128, and resiliently abuts the stripper pad 110. A plurality of cutouts (not shown) is defined in a top face of the second punch holder 108, in communication with the through holes 118 respectively.

The second lower die 140 sequentially comprises from top to bottom: a second lower plate 142, a second lower pad 144, and a second die set 146. The second lower plate 142, second lower pad 144 and second die set 146 are secured together by a plurality of more second pins 103 and second bolts 104. A plurality of locating projections 148 is formed on a top face of the second lower plate 142. Two pairs of second stopping blocks 150 (only one pair shown) are respectively mounted on the second punch set 106 and on the second die set 146, for limiting movement of the second upper die 102 relative to the second lower die 140.

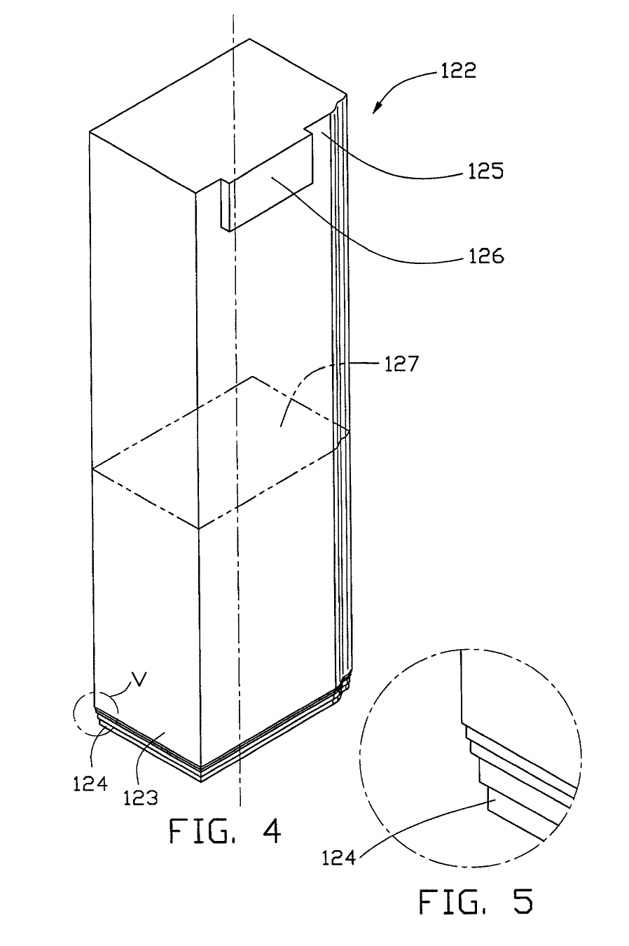

Referring to FIGS. 4 and 5, each second punch 122 comprises a second machining section 123 and a second locking section 125 opposite to the second machining section 123. The second machining section 123 comprises a plurality of progressively stepped machining portions 124. A machining portion 124 nearest the second locking section 125 is the largest, and a machining portion 124 most distal from the second locking section 125 is the smallest, thereby allowing the second punch 122 to cut the burring from the workpiece stepwisedly. A block-shaped protrusion 126 is formed on an upper portion of a side face of the locking section 125, for being accommodated in a corresponding cutout (not shown) of the second punch holder 108. An end face of the protrusion 126 is coplanar with an end face of the locking section 125. A profile 127 of a cross section of the second punch 122 corresponds to a profile of an opening of the workpiece at which the burring exists.

In operation, the workpiece is placed on the support blocks 48 of the first cutting apparatus 10. The waste of the workpiece is located above the first punches 22 of the first lower die 40. The first upper die 12 is moved downwardly toward the first lower die 40. The first punches 22 of the first upper die 12 cut the run and overflow of the waste from the workpiece. The workpiece is then placed on the second lower plate 142 of the second cutting apparatus 100, and positioned by the locating projections 148. The second upper die 102 is moved downwardly toward the second lower die 140. The upper stripper 112 is thus moved downwardly until it abuts the workpiece. The second upper die 102 is continued to be moved downwardly. The second punch set 106 and second punch holder 108 are thus moved downwardly relative to the stripper pad 110, and the spring 130 is compressed. The second punches 122 protrude below the upper stripper 112, and the machining portions 124 of the second punches 122 cut the burring from the workpiece stepwisedly. After the burring is cut away, the second upper die 102 is moved back upwardly. The spring 130 returns back to its original state, thereby causing the stripper pad 110 and upper stripper 112 to move away from the second punch holder 108. The distal ends of the second punches 118 return to their original positions entirely within the through holes 118 of the upper stripper 112.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for removing waste from a workpiece, the waste comprising run, overflow and burring, the method comprising the steps of:
a) providing a first cutting apparatus comprising a first upper die and a first lower die, at least one of the first upper die and the first lower die comprising a first punch, the first punch comprising a first locking section and a wedge-shaped first machining section;
b) removing the run and the overflow via the first cutting apparatus;
c) providing a second cutting apparatus; and
d) removing the burring via the second cutting apparatus.

2. The method as claimed in claim 1, wherein at least one pair of aligned first punches is respectively secured in the first upper die and first lower die.

3. The method as claimed in claim 2, wherein the first upper die sequentially comprises a first punch set, a first punch pad, and a first punch holder secured together by a plurality of first pins and first bolts, and wherein one of the first punches of the at least one pair of first punches that is secured in the first upper die is secured in the first punch holder.

4. The method as claimed in claim 3, wherein the first locking section defines a hole for extension of a screw therethrough to engage with the first punch holder.

5. The method as claimed in claim 2, wherein the first lower die sequentially comprises a first lower plate, a first lower pad and a first die set secured together by a plurality of first pins and first bolts, and wherein the other first punch of the at least one pair of first punches that is secured in the first lower die is secured in the first lower plate.

6. The method as claimed in claim 1, wherein a plurality of supporting blocks is mounted on the first lower die for supporting the workpiece.

7. The method as claimed in claim 1, wherein the second cutting apparatus comprises:
a second upper die;
a second lower die; and
a plurality of second punches secured in the second upper die, each of the second punches comprising a second locking section and a stepped second machining section opposite to the second locking section.

8. The method as claimed in claim 7, wherein the second machining section comprises a plurality of progressively stepped machining portions, one of the machining portions that is nearest the second locking section being larger than all the other machining portions, another of the machining portions that is most distal from the second locking section being smaller than all the other machining portions, thereby allowing the corresponding second punch to cut burring stepwisedly.

9. The method as claimed in claim 7, wherein the second upper die sequentially comprises a second punch set, a second punch holder, a stripper pad, and an upper stripper, the second punch set and the second punch holder are secured together by a plurality of second pins and second bolts, the stripper pad and the upper stripper are secured together by a plurality of second pins and second bolts, and the second punches that are secured in the second upper die are secured in the second punch holder.

10. The method as claimed in claim 9, wherein a plurality of sets of aligned holes is defined in the second punch holder, and stripper pad and upper stripper respectively, and wherein the second punches are fixedly engaged in corresponding said holes of the second punch holder, the second punches movably extend through corresponding said holes of the stripper pad, and the second punches are movably received in corresponding said holes of the upper stripper.

11. The method as claimed in claim 9, wherein the second punch holder defines a through opening, the second punch set defines a recess in communication with the through opening, and wherein a spring is accommodated in the recess and the through opening, and abuts the stripper pad.

12. A cutting apparatus for removing waste from a workpiece, the waste comprising run and overflow, the cutting apparatus comprising:
an upper die sequentially comprising a punch set, a punch pad, and a punch holder secured together by a plurality of pins and bolts;
a lower die sequentially comprising a lower plate, a lower pad and a die set secured together by a plurality of pins and bolts; and
a plurality of pairs of aligned punches, each said pair of punches respectively secured in the punch holder and the lower plate, each of the punches comprising a locking section and a wedge-shaped machining section opposite to the locking section.

13. The cutting apparatus as claimed in claim 12, wherein an angle formed by a distal end of the machining section is approximately 60 degrees.

14. The cutting apparatus as claimed in claim 12, wherein at least one pair of aligned stopping blocks is respectively secured on the punch set and the die set.

15. The cutting apparatus as claimed in claim 12, wherein a plurality of supporting blocks are formed on the lower plate within an area demarcated by the pairs of punches.

16. A cutting apparatus for removing burring from a workpiece, the cutting apparatus comprising:
an upper die sequentially comprising a punch set, a punch holder, a stripper pad, and an upper stripper, the punch set and the punch holder being secured together by a plurality of pins and bolts, the stripper pad and the upper stripper being secured together by a plurality of pins and bolts;
a lower die sequentially comprising a lower plate, a lower pad and a die set secured together by a plurality of pins and bolts; and
a plurality of punches secured in the punch holder and extending through the stripper pad into the upper stripper, each of the punches comprising a locking section and a stepped machining section opposite to the locking section, wherein the machining section comprises a plurality of progressively stepped machining portions, one of the machining portions that is nearest the second locking section being larger than all the other machining portions, another of the machining portions that is most distal from the second locking section being smaller than all the other machining portions, thereby allowing the corresponding punch to cut burring stepwisedly.

17. The cutting apparatus as claimed in claim 16, wherein a plurality of sets of aligned holes is defined in the punch holder, the stripper pad and the upper stripper respectively, and wherein the second punches are fixedly engaged in corresponding said holes of the punch holder, the second punches movably extend through corresponding said holes of the stripper pad, and the second punches are movably received in corresponding said holes of the upper stripper.

18. The cutting apparatus as claimed in claim 16, wherein the punch holder defines a through opening, the punch set defines a recess in communication with the through opening, and wherein a spring is accommodated in the recess and the through opening, and abuts the stripper pad.

19. The cutting apparatus as claimed in claim 16, wherein a plurality of locating projections is formed on the lower plate of the lower die for locating the workpiece on the lower plate.

20. The cutting apparatus as claimed in claim 16, wherein at least one pair of aligned stopping blocks is respectively secured on the punch set and the die set.

21. The cutting apparatus as claimed in claim 16, wherein a profile of a cross section of each of the punches corresponds to a profile of an opening of the workpiece at which burring exists.
